(19) United States
(12) Patent Application Publication
(10) Pub. No.: US 2013/0116025 A1
(43) Pub. Date: May 9, 2013

(54) Method For Playing A Card Game

(71) Applicant: Ronald Chamberlain, Lebanon, CT (US)

(72) Inventor: Ronald Chamberlain, Lebanon, CT (US)

(21) Appl. No.: 13/698,553

(22) PCT Filed: May 18, 2011
(86) PCT No.: PCT/US11/37047

§ 371 Date: Dec. 13, 2012

Related U.S. Application Data
(60) Provisional application No. 61/346,615, filed on May 20, 2010.

(51) Int. Cl. A63F 1/00; G07F 17/32

(52) U.S. Cl. CPC A63F 1/00; G07F 17/3293
USPC 463/12; 273/274

(57) ABSTRACT

A card game having multiple rounds of play. The player places first and second bets that correspond to a first and second round of play, respectively. The first round is Blackjack wherein the player receives two cards. The player will win the Blackjack round if either the player attains Blackjack and the dealer does not attain Blackjack, or if both the player and the dealer attain Blackjack but the player's Blackjack hand out-ranks the dealer's Blackjack hand. If the player wins the Blackjack round, he receives winnings and advances to the next round. If the player does not achieve Blackjack but has a qualifying hand, the player still advances to the second round and receives a third card in order to form a three-card hand. If the player's three-card hand matches any one of a plurality of predetermined three-card hands, the player will advance to the Jackpot round. The player will also be declared the winner of the second round and receive winnings based on his second bet if he attains one of the predetermined three-card hands and his hand outranks the dealer's hand. However, even if the player's three-card hand does not outrank the dealer's hand, the player will still advance to the Jackpot round as long as the player has one of the predetermined three-card hands. If the player enters the Jackpot round, he must place a third bet. He then receives two additional cards so the player can form a five-card hand. The player will win the Jackpot if (i) the player's five-card hand matches any one of the predetermined five-card hands and the dealer's five-card hand does not match any of the predetermined five-card hands, or (ii) both the player and the dealer attain a hand that matches one of the predetermined five-card hands but the player's hand outranks the dealer's hand. If the dealer is not eligible to advance to the second round and the player is eligible to advance to the second round, the player shall still advance to the second round without the dealer, but the second round shall constitute the final round. In such a scenario, there is no Jackpot round.

### CROSS-REFERENCE TO RELATED APPLICATIONS

This application claims the benefit of U.S. provisional application No. 61/346,615, filed May 20, 2010. The entire disclosure of U.S. provisional application No. 61/346,615 is hereby incorporated by reference.

### TECHNICAL FIELD

The present invention generally relates a method for playing a card game.

### BACKGROUND ART

Casinos and wagering establishments are always looking for new, novel and exciting card games that entice players to play such card games and hold the players' interest. New and exciting card games increase revenues for casinos and other wagering establishments. On the other hand, prospective, players are always looking for new card games that are challenging and exciting. Some examples of well-known card games are Let It Ride Bonus Stud Poker, described in U.S. Pat. No. 5,288,081, Three Card Poker, described in U.S. Pat. No. 5,685,774, and Caribbean Stud Poker, described in U.S. Pat. No. 4,836,533.

### DISCLOSURE OF THE INVENTION

It is an object of the present invention to provide a new method for playing cards that generates additional unpredictability, excitement, and revenue for both players and casinos in comparison to traditional card games. Other objects and advantages of the present invention will be apparent in view of the ensuing description of the present invention.

Accordingly, in one aspect, the present invention is directed to a method of playing a card game having multiple rounds, the card game being played on top of a table layout having a dealer location with a card area associated therewith and at least one player location with a card area and a plurality of betting areas associated therewith, said method comprising:
providing at least one deck of cards, wherein the deck of cards is comprised of only Tens, Jacks, Queens, Kings and Aces;
placing bets in the respective betting areas on the table by at least one player in order to play a first and second round of the card game, wherein the bets comprise first and second bets;
dealing an initial hand of two cards face up to each player on top of the corresponding card areas and dealing one card face up and one card face down to the dealer on top of the corresponding card area;
determining if the player has a hand that constitutes Blackjack;
requiring the player to surrender his first bet if the player does not have Blackjack;
if the player's hand constitutes Blackjack, then determining if the dealer's hand constitutes Blackjack;
if both the dealer's hand and player's hand constitute Blackjack, then determining if the player's Blackjack hand beats the dealer's Blackjack hand by determining a ranking of the dealer's Blackjack hand and a ranking of the player's Blackjack hand in accordance with the following table of rankings:

| HAND | RANKING |
|---|---|
| ACE, KING | 4 |
| ACE, QUEEN | 3 |
| ACE, JACK | 2 |
| ACE, TEN | 1 |

wherein “4” is the highest ranking and “1” is the lowest ranking;
declaring the player the winner of the first round if the player's Blackjack hand has a ranking that is higher than the ranking of the dealer's Blackjack hand and awarding winnings to the player based on the player's first bet;
declaring a tie and returning the player's first bet to him if both the player and the dealer have Blackjack and their hands have the same ranking;
thereafter, determining the eligibility of the player and dealer to continue to the second round of play, wherein the dealer and player are eligible to continue to the second round of play if the player's initial hand of two cards and the dealer's initial hand of two cards potentially allow them to attain any of the following hands: unsuited 3-of-a-kind, or suited 3-of-a-kind, or a 3-card straight-flush;
if the player is not eligible to advance to the second round, then requiring the player to surrender his first bet, returning the player's second bet to him and requiring the player to withdraw from the game, and if the dealer is not eligible to advance to the second round, then requiring the dealer to withdraw from play with the exception of his duties as the dealer; advancing the player to the second round of play if the player is eligible and dealing a third card to the player to enable the player to attain a three-card hand and advancing the dealer to the second round of play if the dealer is eligible and dealing a third card to the dealer to enable the dealer to attain a three-card hand;
thereafter determining if the player's hand and the dealer's hand constitute any of the following hands: unsuited 3-of-a-kind, or suited 3-of-a-kind, or a 3-card straight-flush;
if the player's hand does not constitute an unsuited 3-of-a-kind, or suited 3-of-a-kind, or a 3-card straight-flush, then requiring the player to surrender his second bet and withdraw from play, and if the dealer's hand does not constitute an unsuited 3-of-a-kind, or a suited 3-of-a-kind, or a 3-card straight-flush, then requiring the dealer to withdraw from play with the exception of his duties as dealer;
awarding winnings to the player based on the player's second bet if the player's hand constitutes an unsuited 3-of-a-kind, or a suited 3-of-a-kind, or a 3-card straight-flush and the dealer's hand does not constitute an unsuited 3-of-a-kind, or a suited 3-of-a-kind, or a 3-card straight-flush;
if both the dealer's hand and the player's hand constitute an unsuited 3-of-a-kind, or a suited 3-of-a-kind, or a 3-card straight-flush, then determining the ranking of the dealer's hand and the player's hand in accordance with a predetermined table of rankings; and
thereafter, declaring the player the winner of the second round and awarding the player winnings based on his second bet if the player's hand outranks the dealer's hand; and
wherein if the dealer was not eligible to advance to the second round and the player did advance to the second round, then the second round shall be the final round of the card game.

### BRIEF DESCRIPTION OF THE DRAWINGS

Although the scope of the present invention is much broader than any particular embodiment, a detailed description of the preferred embodiments follows together with illustrative figures, wherein like reference numerals refer to like components, and wherein:

FIG. 1 is a diagram of a gaming table of the type that may be used to facilitate a live embodiment of the present invention;

FIG. 2 is a diagram of an electronic gaming machine on which the card game of the present invention is played; and

FIG. 3 is a block diagram of the interconnection of the main components of the electronic gaming machine of FIG. 2.

### BEST MODE FOR CARRYING OUT THE INVENTION

The ensuing description uses the terms “suited” and “unsuited”. These terms are well known in the art. A hand consisting of cards of the same suit is referred to as “suited”, while a hand consisting of cards of different suits is referred to as “unsuited”.

The ensuing description uses the term “outrank”. A first hand of cards will outrank a second hand of cards if the first hand of cards has a ranking that is higher than the ranking of the second hand of cards, wherein the rankings are based on a predetermined table of rankings.

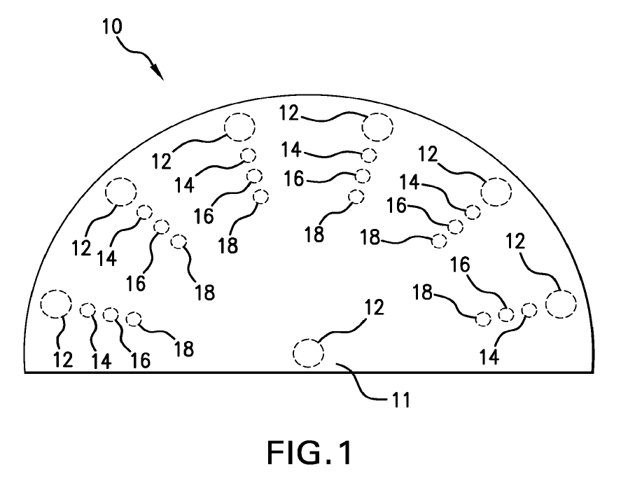

The card game of the present invention is played on a table by at least one player and a dealer. The card game of the present invention may be played with up to six players plus the dealer. The dealer usually represents the house or the casino in the play of the game. Referring to FIG. 1, there is shown one embodiment of a table suitable for playing the card game of the present invention. Table 10 has a dealer station 11, a plurality of card receiving areas 12 for the players and the dealer, and wagering areas 14 for the players to place their first bet or ante wager. Table 10 includes wagering areas 16 for the players to place second bets and wagering areas 18 for third bets. In one embodiment, the card table may have printed thereon the appropriate payout schedule that corresponds to the card game of the present invention.

In accordance with the invention, each deck of cards used to play this card game consists only of Tens, Jacks, Queens, Kings and Aces. Therefore, each deck of cards contains only twenty (20) cards and does not contain any Twos, Threes, Fours, Fives, Sixes, Sevens, Eights or Nines. In a preferred embodiment, the card game of the present invention is preferably played with at least three (3) decks of cards. The card game can be played with up to twenty-two (22) decks. In one embodiment, all of the sets of cards are contained in a shoe, known in the art, from which the dealer may draw one card at a time. In another embodiment, the cards are contained in an automatic card shuffler.

The card game of the present invention can be implemented on an electronic gaming machine such as an electronic video gaming machine. In such electronic gaming machines, images of playing cards are electronically generated and then displayed on a display screen. Additionally, the card game of the present invention can be realized with a lottery scratch ticket wherein images of playing cards are covered by a substance that is removed by players with a coin or other suitable object. U.S. Pat. No. 6,572,107 shows a typical structure of such lottery scratch-type tickets. Thus, the terms “cards”, “playing cards” or “hand” are defined herein to include:
a) physical playing cards,
b) computer-generated images of playing cards,
c) graphically generated images of playing cards, and
d) images of playing cards formed on lottery scratch-type tickets.

In accordance with one embodiment of the invention, Table I is provided below which shows the ranking of all possible hands for the card game of the present invention wherein a 5-card straight-flush has the greatest ranking and 3-of-a-kind (unsuited) has the lowest rank.

TABLE I

| HAND | RANKING |
|---|---|
| 5 Card Straight-Flush | 9 |
| 5 of a Kind (suited) | 8 |
| 5 of a Kind (unsuited) | 7 |
| 4 Card Straight-Flush | 6 |
| 4 of a Kind (suited) | 5 |
| 4 of a Kind (unsuited) | 4 |
| 3 Card Straight-Flush | 3 |
| 3 of a Kind (suited) | 2 |
| 3 of a Kind (unsuited) | 1 |

wherein the ranking of “9” is the highest ranking and the ranking of “1” is the lowest ranking. It is to be understood that the rankings of Table I are in accordance with one embodiment of the invention and that different rankings may be assigned to the hands of cards shown in Table I. For example, in another embodiment, an unsuited 5-of-a-kind may be assigned the highest ranking and a 5-card straight-flush may be assigned a relatively lower ranking.

When both the player's hand and the dealer's hand contain the same number of cards, whoever has the highest ranking card in their hand will win. For example, if the dealer and player each have a five-card straight-flush, and the dealer has a KING which outranks any of the cards the player has in his hand, then the dealer will win. In another example, if the dealer and the player each have an unsuited three-of-a kind and the player has a QUEEN which outranks each card that the dealer has in his hand, then the player will win. In the event of a tie wherein the highest ranking card in the dealer's hand is the same as the highest ranking card in the player's hand, then the second highest ranking card in the dealer's hand and in the player's hand are used to break the tie. In the event the second highest ranking cards have the same ranking and cannot break the tie, then the third highest ranking card in the dealer's hand and in the player's hand are used to break the tie. In the event the tie cannot be broken with the third highest ranking cards, this process will continue with the fourth highest ranking cards and fifth highest ranking cards. If the tie cannot be broken, then a push is declared.

Step 1: Placing of Bets.

The player places a first bet or ante in order to receive an initial hand for the Blackjack round. The player also places a second bet in order to participate in the second round. The second bet allows the player to receive a third card for play in the second round if the player should advance to the second round.

Step 2: Start of Blackjack Round.

Next, the dealer deals two cards face up to each player. The dealer deals himself or herself one card face up and one card face down. The dealer preferably deals the initial two-card hand in a left-to-right motion starting from the dealer's left.

Step: 3: Determination of the Winner of the Blackjack Round.

In order to win this round, the player must have Blackjack and this Blackjack hand must beat the dealer's hand (assuming the dealer also has Blackjack). In order for the player to win the Blackjack round, the player must have a Blackjack hand that beats the dealer's blackjack hand. Table II shows the possible blackjack hands and the ranking assigned to each hand. A ranking of four is the highest and a ranking of one is the lowest.

TABLE II

| HAND | RANKING |
|---|---|
| ACE, KING | 4 |
| ACE, QUEEN | 3 |
| ACE, JACK | 2 |
| ACE, TEN | 1 |

Thus, if the player has Blackjack and his hand consists of ACE, KING and the dealer also has Blackjack but his hand consists of ACE, 10, the player will win the first round and will receive winnings based on his first bet. If the player does not attain Blackjack, or if he does attain Blackjack but his hand does not beat the dealer's hand, the player will lose the first bet. Thus, even if the dealer does not achieve Blackjack, the player will still lose his first bet if the player does not achieve Blackjack. If the player's Blackjack hand matches the dealer's Blackjack hand, it is a push and the player's first bet is returned to the player.

Step 4: Determination of Eligibility of Each Player and Dealer to Play Second Round

Whether or not the player wins the first round (i.e. Blackjack Round), the player's hand and dealer's hand must meet certain criteria in order to advance to the second round. The player's hand must have a pair of cards that will allow the player to attain any of the following hands:
3-of-a-kind (unsuited) (e.g. 10 Hearts, 10 Spades, 10 Clubs)
3-of-a-kind (suited) (e.g. Ace Hearts, Ace Hearts, Ace Hearts)
3-card straight-flush (e.g. Jack Hearts, Queen Hearts, King Hearts)
   If the player's hand does not consist of two cards that would allow him to attain an unsuited 3-of-a-kind, a suited 3-of-a-kind, or a 3-card-straight flush, then the player does not advance and is out. He loses his first bet, but his second bet is returned to him.

Similarly, whether or not the dealer wins the Blackjack Round, the dealer can only advance to the second round if the dealer's hand has a pair of cards that will allow the dealer to attain an unsuited 3-of-a-kind, a suited 3-of-a-kind, or a 3-card-straight flush. If the dealer's hand does not qualify, he or she does not advance to the second round and is out.

Step 5: The Second Round.

If the dealer and player are eligible, they advance to the second round. If the dealer's hand does not qualify for advancement to the second round, but the player's hand does qualify the player to advance the second round, the player may advance to the second round without the dealer. However, in such a scenario, the second round will become the final round of the card game. There will be no further rounds to the game.

In the second round, the dealer and the player receive a third card to see if they can attain any of the aforementioned hands: unsuited 3-of-a-kind, suited 3-of-a-kind, or a 3-card-straight flush. If the player does not attain any of these three hands, the player loses his second bet and is out. If the player attains any of these three hands, the player will advance to the Jackpot round. If the player attains any of these three hands and his hand beats the dealer's hand in accordance with the rankings in Table I, the player receives winnings based on his second bet. If the player attains any of these three hands but the player's hand does not beat the dealer's hand, the player loses his second bet, but still advances to the Jackpot round. If the dealer attains any of these three hands, he will advance to the Jackpot round. If the dealer's hand and the player's hand have the same ranking, a push occurs and the player's second bet is returned to him. In the event of a push in this round, the player and the dealer still advance to the Jackpot round. If the dealer does not attain any of these three hands, the dealer does not advance to the Jackpot round but continues his duties as dealer.

Step 6: The Jackpot Round.

If the dealer and player are eligible, they advance to the Jackpot round. The player now places a third bet in order to continue to play. In a preferred embodiment, this third bet must be a double wager that is twice the amount of the first bet. In an alternate embodiment, the third bet must be a double wager that is twice the amount of the second bet. In this round, the dealer and the players receive two additional cards in order to see if they can attain any of the following five-card hands:
5-of-a-kind (unsuited) (e.g. 10 Hearts, 10 Spades, 10 Clubs, 10 Diamonds, 10 Spades)
5-of-a-kind (suited) (e.g. Ace Hearts, Ace Hearts, Ace Hearts, Ace Hearts, Ace Hearts)
5-card straight-flush (e.g. 10 Spades, Jack Spades, Queen Spades, King Spades, Ace Spades)
   The player will win the Jackpot payout if:
a) the player attains any of these five-card hands but the dealer does not attain any of these five-card hands; or
b) the player and dealer each attain one of these five-card hands but the player's hand outranks the dealer's hand based on the rankings defined in Table I.
   If the player does not attain any of these five-card hands, the player does not win the Jackpot payout but keeps any winnings he previously won.

Similarly, the dealer will win the Jackpot payout if:
a) the dealer attains any of these five-card hands but the player does not attain any of these five-card hands; or
b) the player and dealer each attain one of these five-card hands but the dealer's hand outranks the player's hand based on the rankings defined in Table I.

The card game of the present invention can be played: (i) in a casino or other wagering establishment in a manner similar to conventional card games, i.e. “live table version” wherein a group of players and a dealer are positioned at a gaming table, (ii) on electronic video gaming machines that are located in a casino or other wagering establishment, or (iii) on linked, electronic video gaming machines located in a casino or wagering establishment. Electronic video gaming machines are generally described in U.S. Pat. Nos. 5,823,873, 6,478,675 and 6,517,074, the disclosures of which patents are hereby incorporated by reference.

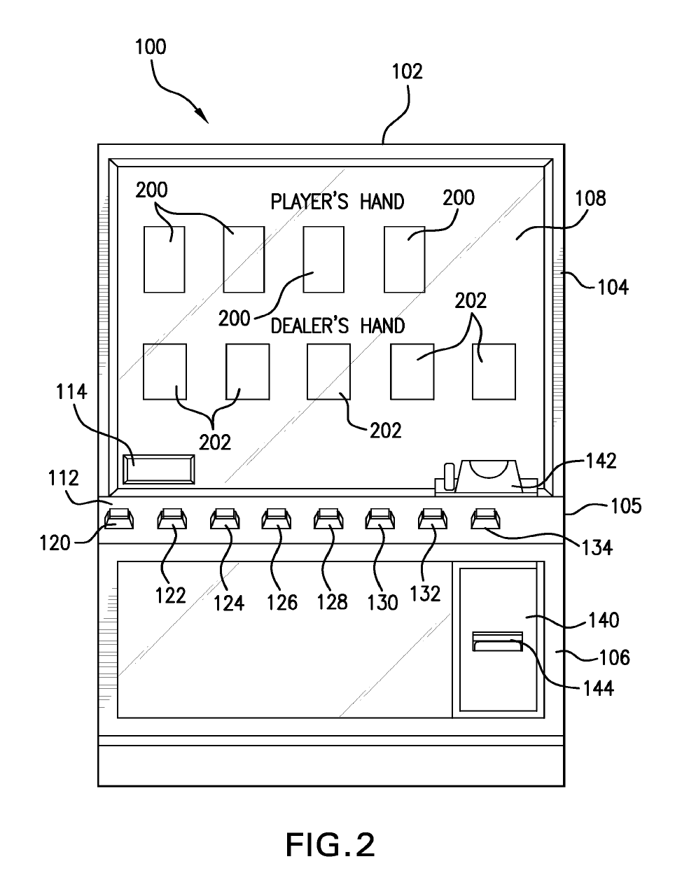

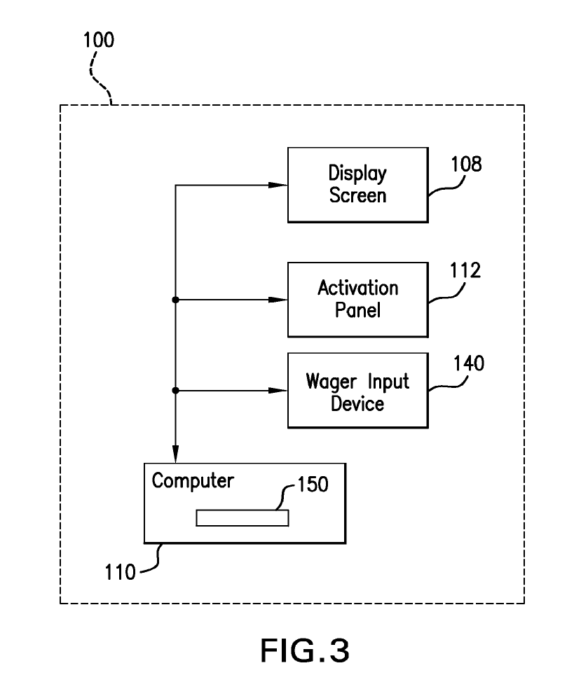

Referring to FIGS. 2 and 3, there is shown a diagram of an electronic gaming machine on which the card game of the present invention is played in accordance with one embodiment. Electronic gaming machine 100 comprises console 102 which has an upper section 104, middle section 105 and lower section 106. Electronic gaming machine 100 further comprises display screen 108, computer 110 and activation panel 112. Computer 110 is in electronic data signal communication with display screen 108 and activation panel 112. Display screen 108 may be configured as a video screen display or an LCD (Liquid Crystal Display). Display screen 108 is mounted on upper section 104 of console 102. Display screen 108 displays the playing cards that will be used during the play of the card game. Thus, display screen 108 displays the player's hand of cards 200 and also displays the dealer's hand of cards 202. The particular quantity of cards shown on display screen 108 in FIG. 2 is for purposes of example only. Display screen 108 also displays other information and data to the player to allow the player to understand the play of the game and the progress of the game. In a preferred embodiment, display screen 108 displays credit meter 114. Display screen 108 displays the amount of first, second and third bets and whether the player has doubled down on his first bet in the Blackjack round. Display screen 108 also displays information related to the winner of the different rounds of the card game (e.g. dealer or player) and the amount of any winnings awarded to the player. Display screen 108 also includes touch screen locations to allow the player to initiate any one of numerous actions. A “CASH OUT” button 120 is provided to allow the player to collect any credits that the player has accrued on credit meter 114. Button 122 allows the player to place the first bet or ante and start the game. Activation panel 112 also includes “DOUBLE DOWN” button 124 which allows the player to double down on his first bet in the Blackjack round. Activation panel 112 includes “NO DOUBLE-DOWN” button 132 which allows a player to choose not to double down on his bet. Activation panel 112 includes buttons 126 and 128 to allow the player to place his second and third bets, respectively. Activation panel 112 includes “BET MAX” button 130 which allows a player to bet the maximum amount of credits. Thus, if a player wishes to place only the minimum bet or credit for a round, he would press buttons 122, 126 and 128 for the first, second and Jackpot rounds, respectively. However, if the player pressed the “BET MAX” button 130 at the beginning of each round, then he would bet the maximum amount of credits for that round. Electronic gaming machine 100 also includes button 134 which is used for other functions. In an alternate embodiment, activation panel 112 is configured as a touch screen. Electronic gaming machine 100 further comprises wager input device 140 that comprises two portions. The first portion is coin slot 142 which allows the player to insert coins or tokens. The second portion of wager input device 140 is device 144 which is configured to accept bills, vouchers, coupons, or other suitable script. Wager input device 140 includes electronic circuitry, well known in the art, which generates electronic data signals representing the amount and type of wager. These electronic data signals are inputted into computer 110. Computer 110 comprises a processor 150 and sufficient memory such as read-only-memory (ROM) and random access memory (RAM). Electronic data representing each card in a deck of playing cards is stored in the memory of computer 110. Computer 110 also comprises other electronic circuits such as cache memory, signal processing circuits and driver circuitry which are known in the art. Computer 110 is programmable and can be programmed with a predetermined pay-out table or pay schedule. Computer 110 implements many functions such as randomly shuffling a deck (or decks) of cards and analyzing the hands of cards held by the dealer and the player, and analyzing the hand of cards held by the dealer or player. Thus, computer 110 is also programmed with the rules of the card game and any predetermined tables of rankings of hands. Accordingly, this embodiment of the invention is directed to a method of playing a card game on an electronic gaming machine 100, comprising the steps of:
(a) providing an electronic gaming machine 100 comprising a display screen 108, activation panel 112, wager input device 140 and a computer 110, wherein the computer 110 is in electronic signal communication with the display screen 108, activation panel 112 and wager input device 140, the computer 110 comprising a processor programmed to execute the steps of the card game and analyze the player's hand of cards and the dealer's hands of cards to determine the winner of each round of play and the winner of a Jackpot;
(b) displaying, on the display screen 108, at least three deck of cards, wherein each deck of cards consists of Tens, Jacks, Queens, Kings and Aces;
(c) the player using the wager input device 140 to place bets in order to play a first round and a second round of the card game, wherein the bets comprise first and second bets;
(d) displaying, on the display screen 108, a deal of an initial hand of two cards face up to each player and one card face up and one card face down to the dealer;
(e) using the computer 110 to determine if the player has a hand that constitutes Blackjack and if the dealer has a hand that constitutes Blackjack;
(f) if the player does not have Blackjack, then using display screen 108 to inform the player that he has lost his first bet;
(g) if both the dealer's hand and player's hand constitute Blackjack, then using the computer 110 to determine if the player's Blackjack hand beats the dealer's Blackjack hand by determining a ranking of the dealer's Blackjack hand and a ranking of the player's Blackjack hand in accordance with the following table of rankings:

| HAND | RANKING |
|---|---|
| ACE, KING | 4 |
| ACE, QUEEN | 3 |
| ACE, JACK | 2 |
| ACE, TEN | 1 |

wherein “4” is the highest ranking and “1” is the lowest ranking and wherein a tie or push is declared if the ranking of the dealer's Blackjack hand and the player's Blackjack hand is the same;
(h) using display screen 108 to declare the player the winner of the first round if the computer determines that the player's Blackjack hand has a ranking that is higher than the ranking of the dealer's Blackjack hand and awarding winnings to the player based on the player's first bet;
(i) using the display screen 108 to declare a tie and returning the player's first bet to him if the computer 110 determines that both the player and the dealer have Blackjack and the ranking of the player's hand is the same as the ranking of the dealer's hand;
(j) thereafter, using the computer 110 to determine the eligibility of the player and dealer to advance to the second round of play, wherein the dealer and player are eligible to advance to the second round of play if the player's initial hand of two cards and the dealer's initial hand of two cards allow them to attain an unsuited 3-of-a-kind, or a suited 3-of-a-kind or a 3-card straight-flush;
(k) if the player is not eligible to advance to the second round, then requiring the player to surrender his first bet, returning the player's second bet to him and requiring the player to withdraw from further play, and if the dealer is not eligible to advance to the second round, then requiring the dealer to withdraw from further play with the exception of his duties as the dealer;
(l) advancing the player to the second round of play if the player is eligible and displaying on display screen 108 a deal of a third card to the player to enable the player to attain a three-card hand, and advancing the dealer to the second round of play if the dealer is eligible and displaying on the display screen 108 a deal of a third card to the dealer to enable the dealer to attain a three-card hand, wherein if the player is eligible to advance to the second round but the dealer is not eligible to advance to the second round, the player may still advance to the second round without the dealer but the second round will become the final round of the card game;
(m) thereafter, using the computer 110 to determine if the player's hand and the dealer's hand constitute an unsuited 3-of-a-kind, a suited 3-of-a-kind or a 3-card straight-flush;
(n) if the player's hand does not constitute an unsuited 3-of-a-kind, or a suited 3-of-a-kind, or a 3-card straight-flush, then requiring the player to surrender his second bet and withdraw from further play, and if the dealer's hand does not constitute an unsuited 3-of-a-kind, or a suited 3-of-a-kind, or a 3-card straight-flush, then requiring the dealer to withdraw from further play with the exception of his duties as dealer;
(o) awarding winnings to the player based on the player's second bet if the player's hand constitutes an unsuited 3-of-a-kind, or a suited 3-of-a-kind, or a 3-card straight-flush and the dealer's hand does not constitute an unsuited 3-of-a-kind, or a suited 3-of-a-kind or a 3-card straight-flush;
(p) if both the dealer's hand and the player's hand constitute an unsuited 3-of-a-kind, a suited 3-of-a-kind or a 3-card straight-flush, then using the computer 110 to determine the ranking of the dealer's hand and the player's hand in accordance with the foregoing Table I;
(q) thereafter, declaring the player the winner and awarding the player winnings based on his second bet if the player's hand outranks the dealer's hand;
(r) advancing the player to the Jackpot round if the (i) the player was declared the winner of the second round, or (ii) the player was not declared the winner of the second round but he did attain one the following hands: an unsuited 3-of-a-kind, a suited 3-of-a-kind or a 3-card straight-flush; and
(s) advancing the dealer to the Jackpot round if (i) the dealer was declared the winner of the second round, or (ii) the dealer was not declared the winner of the second round but the dealer did attain one the following hands: an unsuited 3-of-a-kind, a suited 3-of-a-kind or a 3-card straight-flush.

If the player enters the Jackpot round, the player must place a third bet in order to continue to play. The player can use wager input device 140 to place the third bet. In a preferred embodiment, this third bet must be a double wager that is twice the amount of the first bet. In an alternate embodiment, the third bet must be a double wager that is twice the amount of the second bet. After the player places the third bet, display screen 108 displays a deal of two more cards to the player. If the dealer also makes it to the Jackpot round, display screen 108 also displays a deal of two more cards to the dealer. Computer 110 analyzes the five-card hands to see if the player and dealer have attained any of the following five-card hands:
5-of-a-kind (unsuited) (e.g. 10 Hearts, 10 Spades, 10 Clubs, 10 Diamonds, 10 Spades)
5-of-a-kind (suited) (e.g. Ace Hearts, Ace Hearts, Ace Hearts, Ace Hearts, Ace Hearts)
5-card straight-flush (e.g. 10 Spades, Jack Spades, Queen Spades, King Spades, Ace Spades)
   The player will win the Jackpot payout if:
c) the player attains any of these five-card hands but the dealer does not achieve any of these five-card hands; or
d) the player and dealer each attain one of these five-card hands but the player's hand outranks the dealer's hand based on the rankings defined in the foregoing Table I.
   If the player does not achieve any of these five-card hands, the player does not win the Jackpot payout but keeps any winnings he previously won in the Blackjack and second rounds.

Similarly, the dealer will win the Jackpot payout if:
c) the dealer attains any of these five-card hands but the player does not attain any of these five-card hands; or
d) the player and dealer each attain one of these five-card hands but the dealer's hand outranks the player's hand based on the rankings defined in the foregoing Table I.

It is to be understood that instead of using wager input device 140, the player may use credits when placing bets. Display screen 108 displays the amount of credits in real time and the amount of credits the player is using for a bet. Display screen 108 also displays all information, instructions, and commands pertinent to the play of the game. Display screen 108 also displays player status, dealer status, amount of winnings, and the winner and loser of each round.

### Alternate Embodiments

In an alternate embodiment, during the Blackjack round, the player is given the opportunity to double down on his first bet if the player's initial two-card hand consists of any of the following hands shown in Table III:

TABLE III

TEN, JACK
TEN, QUEEN
TEN, KING
JACK, JACK
JACK, QUEEN
QUEEN, QUEEN

In an alternate embodiment of the invention, the card game of the present invention consists only of the Blackjack Round which is described in Steps 1, 2 and 3 of the foregoing description. In such an embodiment, the player places only an initial bet or ante to play the Blackjack Round but does not place any other bets.

In a further embodiment of the invention, the card game of the present invention consists only of the Blackjack Round and the Second Round. Thus, in this embodiment, the card game of the present invention consists only of Steps 1, 2, 3, 4 and 5. In such an embodiment, the player places only an initial bet or ante to play the Blackjack Round and a second bet to play the Second Round, but does not place any other bets.

In an alternate embodiment of the card game of the present invention, there is a four-card round of play in between the second round and the Jackpot round. In the four-card round, the player would place another bet and the player and dealer would receive one additional card so as to allow them to form a four-card hand. In order to advance to the Jackpot round, the player and dealer must obtain any of the following four card hands: unsuited 4-of-a-kind, suited 4-of-a-kind, or a 4-card straight-flush. The player or dealer will advance to the Jackpot round as long as they have any of these four-card hands, regardless if they lose the round based on the rankings of hands defined in Table I. Thus, if both the player and dealer attain one of these four-card hands, but the dealer's hand outranks the player's hand, the player will still advance to the Jackpot round. The player will win this four-card round and receive winnings on his bet if (i) the player attains any of these four card hands and the dealer does not attain any of these four card hands, or (ii) the player and the dealer both attain one of the four-card hands but the player's hand outranks the dealer's hand. Similarly, the dealer will win this four-card round if (i) the dealer attains any of these four card hands and the player does not attain any of these four card hands, or (ii) the player and the dealer both attain one of the four-card hands but the dealer's hand outranks the player's hand. If the player or dealer do not attain any of these four-card hands, they are out and do not advance to the Jackpot round. If the player does not attain any of these four-card hands, he loses his bet that he placed in this round, but keeps any previously won bets.

In a further embodiment, the Jackpot round comprises the aforementioned four-card round and there is no five-card Jackpot round. In such an embodiment, the card game of the present invention consists only of the Blackjack round, the second round and the four-card Jackpot round.

In another embodiment of the present invention, the card game will automatically end if the dealer's two-card hand does not qualify him to advance to the second round. Thus, the game will automatically end if the dealer's two-card hand in the Blackjack round would not enable him to attain an unsuited 3-of-a-kind, or a suited 3-of-a-kind, or a 3-card straight-flush. If the game should end under these conditions, the players' second bets are returned to the players.

It is to be understood that the betting procedures and protocol of the card game of the present invention may be varied to suit the needs of the house (e.g. casino). For example, the timing of the bets (i.e. when the bets are placed) and the amounts of the bets may be varied depending upon the requirements and needs of the house. In one example, the third bet can be placed at the same time the player places the first and second bets. In another example, the third bet can be three times the amount of the first bet. Many more modifications to the betting protocol are possible.

It is to be understood that rankings of the hands, as shown in Tables I and II, constitute one embodiment, and then such rankings of hands may be varied.

The card game of the present invention can be implemented on slot machines and also implemented with lottery scratch-type tickets that are sold by many state governments.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

What is claimed is:

1. A method of playing a card game having multiple rounds, the card game being played on top of a table layout having a dealer location with a card area associated therewith and at least one player location with a card area and a plurality of betting areas associated therewith, said method comprising:
providing at least three decks of cards, wherein each deck of cards consists of Tens, Jacks, Queens, Kings and Aces;
placing bets in the respective betting areas on the table by at least one player in order to play a first and second round of the card game, wherein the bets comprise first and second bets;
dealing an initial hand of two cards face up to each player on top of the corresponding card areas and dealing one card face up and one card face down to the dealer on top of the corresponding card area;
determining if the player has a hand that constitutes Blackjack;
requiring the player to surrender his first bet if the player does not have Blackjack;
if the player's hand constitutes Blackjack, then determining if the dealer's hand constitutes Blackjack;
if both the dealer's hand and player's hand constitute Blackjack, then determining if the player's Blackjack hand beats the dealer's Blackjack hand by determining a ranking of the dealer's Blackjack hand and a ranking of the player's Blackjack hand in accordance with the following table of rankings:

| HAND | RANKING |
|---|---|
| ACE, KING | 4 |
| ACE, QUEEN | 3 |
| ACE, JACK | 2 |
| ACE, TEN | 1 |

wherein “4” is the highest ranking and “1” is the lowest ranking;
declaring the player the winner of the first round if the player's Blackjack hand outranks the dealer's Blackjack hand and awarding winnings to the player based on the player's first bet;
declaring a tie and returning the player's first bet to the player if both the player and the dealer have Blackjack and the ranking of the player's hand is the same as the ranking of the dealer's hand;
thereafter, determining the eligibility of the player and dealer to continue to the second round of play, wherein the dealer and player are eligible to continue to the second round of play if the player's initial hand of two cards and the dealer's initial hand of two cards potentially allow them to attain any of the following hands: an unsuited 3-of-a-kind, a suited 3-of-a-kind, or a 3-card straight-flush;
if the player is not eligible to advance to the second round, then requiring the player to surrender his first bet, returning the player's second bet to him and requiring the player to withdraw from further play, and if the dealer is not eligible to advance to the second round, then requiring the dealer to withdraw from further play with the exception of his duties as the dealer;
advancing the player to the second round of play if the player is eligible and dealing a third card to the player to enable the player to attain a three-card hand, and advancing the dealer to the second round of play if the dealer is eligible and dealing a third card to the dealer to enable the dealer to attain a three-card hand, wherein if the player is eligible to advance to the second round but the dealer is not eligible to advance to the second round, the player shall still advance to the second round without the dealer and the second round shall become the final round of the card game;
thereafter determining if the player's hand and the dealer's hand constitute an unsuited 3-of-a-kind, a suited 3-of-a-kind, or a 3-card straight-flush;
if the player's hand does not constitute an unsuited 3-of-a-kind, or a suited 3-of-a-kind, or a 3-card straight-flush, then requiring the player to surrender his second bet and withdraw from further play, and if the dealer's hand does not constitute an unsuited 3-of-a-kind, a suited 3-of-a-kind or a 3-card straight-flush, then requiring the dealer to withdraw from further play with the exception of his duties as dealer;
awarding winnings to the player based on the player's second bet if the player's hand constitutes an unsuited 3-of-a-kind, a suited 3-of-a-kind or a 3-card straight-flush and the dealer's hand does not constitute an unsuited 3-of-a-kind, a suited 3-of-a-kind, or a 3-card straight-flush;
if both the dealer's hand and the player's hand constitute an unsuited 3-of-a-kind, or a suited 3-of-a-kind, or a 3-card straight-flush, then determining the ranking of the dealer's hand and the player's hand in accordance with predetermined rankings; and
thereafter, declaring the player the winner and awarding the player winnings based on his second bet if the ranking of the player's hand is higher than the ranking of the dealer's hand.

2. The method of playing a card game according to claim 1 further including the step of, after the initial deal of two cards, providing the player the opportunity to double down on his first bet if the player's hand consist of any of the following hands:
TEN, JACK
TEN, QUEEN
TEN, KING
JACK, JACK
JACK, QUEEN
QUEEN, QUEEN

3. The method of playing a card game according to claim 1 further comprising the step of declaring a tie or a push if the rankings of both the dealer's hand and the player's hand have the same ranking.

4. The method of playing a card game according to claim 1 further comprising the steps of:
advancing the player to a Jackpot round if (i) the player was declared the winner of the second round, or (ii) the player was not declared the winner of the second round but the player did attain one of the following hands: unsuited 3-of-a-kind, a suited 3-of-a-kind or a 3-card straight-flush;
placing a third bet by the at least one player; and
thereafter, dealing two additional cards to the player to enable the player to form a five-card hand.

5. The method of playing a card game according to claim 4 wherein the third bet is a double the amount of the first bet.

6. The method of playing a card game according to claim 4 further comprising the steps:
advancing the dealer to the Jackpot round if in the second round if (i) the dealer was declared the winner of the second round, or (ii) the dealer was not declared the winner of the second round but the dealer did attain one of the following hands: unsuited 3-of-a-kind, a suited 3-of-a-kind or a 3-card straight-flush; and
thereafter, dealing two additional cards to the dealer to enable the dealer to form a five-card hand.

7. The method of playing a card game according to claim 6 further comprising:
analyzing the player's five-card hand to determine if the player has attained any of the following hands: unsuited 5-of-a-kind, a suited 5-of-a-kind or a 5-card straight-flush; and
awarding the Jackpot to the player if (i) the player has attained any of these five-card hands but the dealer has not attained any of these five-card hands, or (ii) the player and the dealer have both attained one of these five-card hands and the player's hand outranks the dealer's hand in accordance with the predetermined rankings;

8. The method of playing a card game according to claim 7 further comprising:
analyzing the dealer's five-card hand to determine if the player has attained any of the following hands: unsuited 5-of-a-kind, a suited 5-of-a-kind or a 5-card straight-flush; and
awarding the Jackpot to the dealer if (i) the dealer has attained any of these five-card hands but the player has not attained any of these five-card hands, or (ii) the dealer and the dealer have both attained one of these five-card hands and the dealer's hand outranks the player's hand in accordance with the predetermined rankings.

9. A method of playing a card game on an electronic gaming machine, comprising the steps of:
providing an electronic gaming machine comprising a display screen, activation panel, wager input device and a computer, wherein the computer is in electronic signal communication with the display screen, activation panel and wager input device, the computer comprising a processor programmed to execute the steps of the card game and analyze the player's and dealer's hands of the cards to determine the winner of each round of play and the winner of a Jackpot;
displaying, on the display screen, at least three decks of cards, wherein each deck of cards consists of Tens, Jacks, Queens, Kings and Aces;
the player using the wager input device to place bets in order to play a first and second round of the card game, wherein the bets comprise first and second bets;
displaying, on the display screen, a deal of an initial hand of two cards face up to each player and one card face up and one card face down to the dealer;
using the computer to determine if the player has a hand that constitutes Blackjack and if the dealer has a hand that constitutes Blackjack;
if the player does not have Blackjack, then displaying on the display screen information to inform the player that he has lost his first bet;
if both the dealer's hand and player's hand constitute Blackjack, then using the computer to determine if the player's Blackjack hand beats the dealer's Blackjack hand by determining a ranking of the dealer's Blackjack hand and a ranking of the player's Blackjack hand in accordance with the following table of rankings:

| HAND | RANKING |
|---|---|
| ACE, KING | 4 |
| ACE, QUEEN | 3 |
| ACE, JACK | 2 |
| ACE, TEN | 1 |

wherein “4” is the highest ranking and “1” is the lowest ranking;
declaring the player the winner of the first round if the computer determines that the player's Blackjack hand has a ranking that is higher than the ranking of the dealer's Blackjack hand and awarding winnings to the player based on the player's first bet;
declaring a tie and returning the player's first bet to him if the computer determines that both the player and the dealer have Blackjack and the ranking of the player's hand is the same as the ranking of the dealer's hand;
thereafter, using the computer to determine the eligibility of the player and dealer to advance to the second round of play, wherein the dealer and player are eligible to advance to the second round of play if the player's initial hand of two cards and the dealer's initial hand of two cards have the potential to enable the player and dealer to attain an unsuited 3-of-a-kind, a suited 3-of-a-kind, or a 3-card straight-flush;
if the player is not eligible to advance to the second round, then requiring the player to surrender his first bet, returning the player's second bet to him and requiring the player to withdraw from further play, and if the dealer is not eligible to advance to the second round, then requiring the dealer to withdraw from further play with the exception of his duties as the dealer;
advancing the player to the second round of play if the player is eligible and displaying on the display screen, a deal of a third card to the player to enable the player to attain a three-card hand, and advancing the dealer to the second round of play if the dealer is eligible and displaying on the display screen a deal of a third card to the dealer to enable the dealer to attain a three-card hand, wherein if the player is eligible to advance to the second round but the dealer is not eligible to advance to the second round, the player shall still advance to the second round without the dealer and the second round shall become the final round of the card game;
thereafter, using the computer to determine if the player's hand and the dealer's hand constitute an unsuited 3-of-a-kind, a suited 3-of-a-kind or a 3-card straight-flush;
if the player's hand does not constitute an unsuited 3-of-a-kind, a suited 3-of-a-kind or a 3-card straight-flush, then requiring the player to surrender his second bet and withdraw from further play, and if the dealer's hand does not constitute an unsuited 3-of-a-kind, or a suited 3-of-a-kind or a 3-card straight-flush, then requiring the dealer to withdraw from further play with the exception of his duties as dealer;
awarding winnings to the player based on the player's second bet if the player's hand constitutes an unsuited 3-of-a-kind, a suited 3-of-a-kind or a 3-card straight-flush and the dealer's hand does not constitute an unsuited 3-of-a-kind, or a suited 3-of-a-kind or a 3-card straight-flush;
if both the dealer's hand and the player's hand constitute an unsuited 3-of-a-kind, a suited 3-of-a-kind or a 3-card straight-flush, then using the computer to determine the ranking of the dealer's hand and the player's hand in accordance with predetermined rankings;
thereafter, declaring the player the winner and awarding the player winnings based on his second bet if the player's hand outranks the dealer's hand.

10. The method of playing a card game according to claim 9 further comprising the step of providing the player the opportunity to double down on his first bet if the player's initial two-card hand consist of any of the following hands:
TEN, JACK
TEN, QUEEN
TEN, KING
JACK, JACK
JACK, QUEEN
QUEEN, QUEEN

11. The method of playing a card game according to claim 9 further comprising the step of declaring a tie or a push if both the dealer and the player have a Blackjack hand of the same ranking.

12. The method of playing a card game according to claim 9 further comprising the steps of:
advancing the player to a Jackpot round if (i) the player was declared the winner of the second round, or (ii) the player was not declared the winner of the second round but the player did attain one of the following hands: unsuited 3-of-a-kind, a suited 3-of-a-kind or a 3-card straight-flush;
placing a third bet by the at least one player; and
thereafter, the display screen displaying a deal of two additional cards to the player so the player is able to form a five-card hand.

13. The method of playing a card game according to claim 12 wherein the third bet is a double the amount of the first bet.

14. The method of playing a card game according to claim 12 further comprising:
analyzing the player's five-card hand to determine if the player has attained any of the following hands: unsuited 5-of-a-kind, a suited 5-of-a-kind or a 5-card straight-flush; and
awarding the Jackpot to the player if (i) the player has attained any of these five-card hands but the dealer has not attained any of these five-card hands, or (ii) the player and the dealer have both attained one of these five-card hands and the player's hand outranks the dealer's hand in accordance with the predetermined rankings.

15. The method of playing a card game according to claim 14 further comprising the steps:
advancing the dealer to the Jackpot round if (i) the dealer was declared the winner of the second round, or (ii) the dealer was not declared the winner of the second round but the dealer did attain one of the following hands: unsuited 3-of-a-kind, a suited 3-of-a-kind or a 3-card straight-flush; and
thereafter, dealing two additional cards to the dealer to enable the dealer to form a five-card hand.

16. The method of playing a card game according to claim 15 further comprising:
analyzing the dealer's five-card hand to determine if the player has attained any of the following hands: unsuited 5-of-a-kind, a suited 5-of-a-kind or a 5-card straight-flush; and
awarding the Jackpot to the dealer if (i) the dealer has attained any of these five-card hands but the player has not attained any of these five-card hands, or (ii) the dealer and the dealer have both attained one of these five-card hands and the dealer's hand outranks the player's hand in accordance with the predetermined rankings.
